(19) United States
(12) Patent Application Publication
(10) Pub. No.: US 2004/0183802 A1
(43) Pub. Date: Sep. 23, 2004

(54) Bold font generator

(76) Inventor: Choong Cheng Chan, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/392,207

(22) Filed: Mar. 19, 2003

(51) Int. Cl. G06T 11/00

(52) U.S. Cl. 345/467

(57) ABSTRACT

A method (48) and digital image device (18) for providing a bolded character bitmap. The device (18) has a memory unit (22) for storing a character bitmap and an input buffer (21a) for receiving character bitmap from the memory unit (22). There is a processor (20) coupled to the input buffer (21a) and in use the processor (20) generates a bolded character bitmap by applying a bolding process that to determines if a neighboring row pixel for each active pixel in the character bitmap is active. The bolding process generates a shifted active pixel, for each active pixel, if the neighboring pixel is active to generate a shifted character bitmap that is displayed on an LCD (26).

### FIELD OF THE INVENTION

The present invention relates generally to generating fonts. More particularly, the present invention relates to a method and apparatus for generating bold fonts in limited memory environments.

### BACKGROUND ART

A font is a set of characters formed with the same typeface and having the same point size. Therefore, each character in the font is designed with a look and feel similar to all other characters in the font. Originally, a font was defined by a case of metal characters that were physically set into a printing press to print text. Currently, fonts are most commonly used by computers and printers, which enable the output of characters having a very large variety of sizes, shapes, and designs. Fonts have also become important to display characters in portable electronic devices such as laptop computers, personal digital assistants (PDAs), and mobile phones.

One method of providing characters for conventional computer displays, such as cathode ray tubes (CRTs) and liquid crystal displays (LCDs), is by bitmapping. A character bitmap is a map of active and inactive pixels, which are pre-made and stored by each electronic device for each character. For example, a specific character bitmap may be characterized as being part of a font, such as Normal 12-point Times New Roman.

FIG. 1 illustrates a conventional character bitmap 10 of a character. In this particular example, the character is “ô”. Character bitmap 10 includes a number of active (black) pixels 12 and a number of inactive (white) pixels 14. In this example, the character bitmap has a height of 11 pixels and a width of 10 pixels. Each pixel is mapped by its position along an x-axis (horizontal) and a y-axis (vertical). For example, active pixel 12′ has an (x,y) position of (3,2). As with all character bitmaps, any modifications such as bolding, italicizing, or changing font require the use of a separate character bitmap. It is possible to use enlarge or shrink bitmaps, however, the quality of the altered bitmap would be lowered dramatically. The greater the difference in size, the more distorted and jagged the appearance.

Other systems of generating characters include PostScript and TrueType fonts, which use mathematical descriptions of the outlines of each character. In contrast to bitmaps, these mathematical descriptions allowed PostScript and TrueType systems to alter fonts while retaining character smoothness. Of course, this type of technological improvement does not come without a price. Both the processing power and the memory required to support PostScript and TrueType systems are much higher than a simple scheme that uses a pre-made bitmap to display text.

As described above, one of the problems with bitmapped fonts is that each character requires its own bitmap. For example, to display a single set of characters in bold font requires an additional set of bolded bitmaps in addition to the standard bitmaps for the normal characters. If bolding is required for the 26 characters in the Roman alphabet, 26 additional bitmaps must be provided. The number of additional bitmaps required by bolding grows very quickly when taking case, size, font, style combinations, and special characters into consideration.

The memory requirement of bolding fonts grows even greater when taking other multi-lingual function is required. For example, the Traditional Chinese Big5 font set includes 13,711 characters alone. If the combination of Chinese, Japanese, and Korean (CJK) characters is about 25,000 characters and each character (at 24 pixel by 24 pixel dimensions) requires 72 bytes to store, the total is 1.72 megabytes (MB). Bold typefaces of these fonts would double the storage required to 3.44 MB. Furthermore, since it may be desirable to bold other font styles, such as underline, italicize, superscript, subscript, and combinations thereof, the number of total bitmaps and corresponding storage requirements may continue to grow exponentially.

Supporting a staggering number of bitmaps becomes even more important when dealing with hand held devices, which are subject to severe processing and memory limitations. Currently, a typical hand held device, such as a mobile phone or a PDA may only have 16 MB of memory, while being run by 16-megahertz (MHz) processors. While pocket personal computers (PCs) may have a bit more processing power and memory, none of the hand held devices are able to support TrueType or Postscript like standard PCs that currently have gigabytes of memory and gigahertz microprocessors.

In addition, forcing a hand held device to store a large number of bitmaps (such as bolded CJK characters) will consume a large percentage of the device's memory and severely limit what other applications may be stored or used. In view of the foregoing, it is desirable to have a method and apparatus for reducing the amount of memory and processing power used when displaying or printing a bold font.

### SUMMARY OF THE INVENTION

According to one aspect of the invention there is provided a method for providing a bolded character bitmap, comprising: detecting an active pixel on a character bitmap; determining if a neighboring row pixel for said active pixel is active; generating a shifted active pixel for said active pixel if said neighboring pixel is not active to generate a shifted character bitmap for each row of pixels in the character bitmap; and combining said character bitmap with said shifted character bitmap to generate said bolded character bitmap.

According to another aspect of the invention there is provided a digital image device, comprising: a memory unit for storing a character bitmap; an input buffer for receiving said character bitmap from said memory unit; a processor coupled to said input buffer, wherein said processor is to generate a bolded character bitmap by applying a bolding process, wherein said bolding process is to determine if a neighboring row pixel for each active pixel in said character bitmap is active; and an output buffer coupled to said processor for storing and transmitting said bolded character bitmap.

According to another aspect of the invention there is provided a method for providing a bolded character bitmap, comprising: detecting an active pixel on a character bitmap; determining if a neighboring row pixel for said active pixel is active; and generating a shifted active pixel for said active pixel if said neighboring pixel is not active to generate said bolded character bitmap.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a conventional character bitmap of a character;

FIG. 2 is a block diagram of a digital image device in accordance with one embodiment of the present invention;

FIG. 3 illustrates a shifted character bitmap having a set of shifted active pixels in accordance with one embodiment of the present invention;

FIG. 4 illustrates a distorted combined character bitmap;

FIGS. 5A and 5B illustrate a standard character bitmap and a bolded character bitmap to demonstrate neighboring pixel detection in accordance with one embodiment of the present invention;

FIG. 6 illustrates a character bitmap after bolding in accordance with one embodiment of the present invention; and

FIG. 7 is a flow chart of a method for providing a bolded character bitmap in accordance with one embodiment of the present invention.

### DETAILED DESCRIPTION OF THE PREFERRED EMBODIMENTS OF THE INVENTION

A method and apparatus for providing a bold font generator are provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

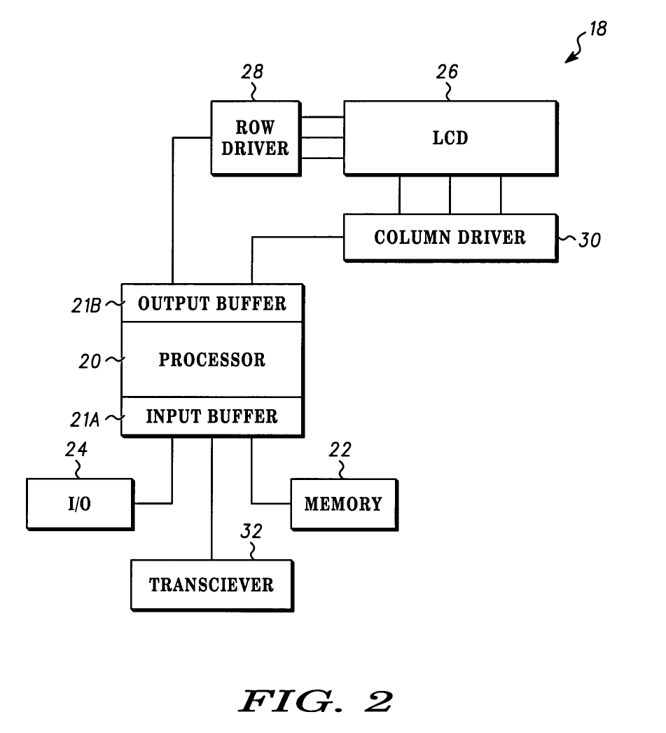

FIG. 2 is a block diagram of a digital image device 18 in accordance with one embodiment of the present invention. Digital image device 18 includes a processor 20 having an input buffer 21a and an output buffer 21b. Processor 20 and input buffer 21a are coupled to a both a memory unit 22 and an input/output (I/O) unit 24. Processor 20 and output buffer 21b are further coupled to a display 26 through a row driver 28 and a column driver 30. Display 26 is a LCD, but as is well known to those skilled in the art, a variety of display devices may be used. Processor 20 may also be coupled to other output devices, such as a printer. In this example, processor 20 is also coupled to a transceiver 32, which is used to receive and transmit wireless data in hand held devices.

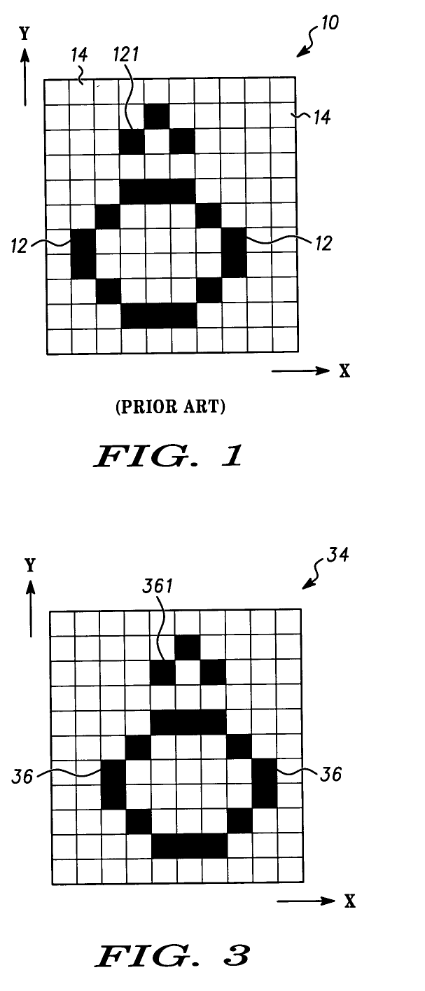

Text may be input to digital image device 18 in a number of ways. For example, if device 18 is a mobile phone, a user may enter a character into I/O unit 24 through a numeric keypad. In another example, a text message may be received by transceiver 32. The text data is received by processor 20, which retrieves the appropriate character bitmaps from memory unit 22, such as character bitmap 10 in FIG. 1, into input buffer 21a. The processor then instructs row driver 28 and column driver 30 to display the character bitmap on LCD 26. When the processor 20 is instructed to output a bolded character, instead of retrieving a different character bitmap of the bolded character from memory unit 22, a normal character bitmap is used. The normal character bitmap, such as character bitmap 10, is then input into a bolding process as described below. The bolded character bitmap resulting from the process is stored by output buffer 21b before being displayed or printed.

FIG. 3 illustrates a shifted character bitmap 34 having a set of shifted active pixels 36 in accordance with one embodiment of the present invention. Referring back to FIG. 1, all of active pixels 12 have been shifted one pixel to the right (x+1) in FIG. 3. To arrive at this result, the processor retrieves character bitmap 10 and detects the positions of each active pixel 12. The processor then creates character bitmap 34 by right shifting the positions by one pixel, resulting in shifted active pixels 36 that are adjacent to original active pixels 12. For example, shifted active pixel 36′ has been right shifted to a position of (4,2) compared to active pixel 12′ in FIG. 1.

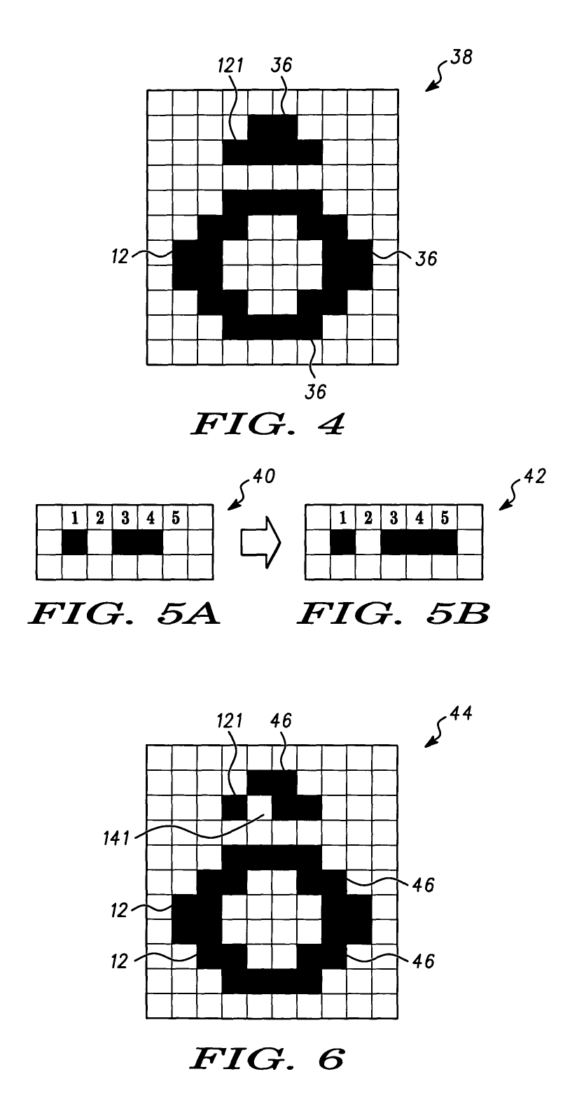

FIG. 4 illustrates a distorted combined character bitmap 38. Combined character bitmap 38 includes both active pixels 12 from character bitmap 10 and shifted active pixels 36 from shifted character bitmap 34. The processor generates combined character bitmap 38 by inputting character bitmap 10 and shifted character bitmap 34 into a digital circuit known as an OR gate. The output of an OR gate is illustrated in the table below, with inactive pixels represented by a low state (i.e., logical “0”) and active pixels by a high state (i.e., logical “1 ”).

| Bitmap 10 | Shifted Bitmap 34 | Combined Bitmap 38 |
|---|---|---|
| 0 | 0 | 0 |
| 1 | 0 | 1 |
| 0 | 1 | 1 |
| 1 | 1 | 1 |

Combined bitmap 38 generates a draft bold effect of the “ô” in original character bitmap 10. While the bolding is successful for the lower portion of the character, the carat at the top of combined bitmap 38 has become distorted. More specifically, an indented portion at the bottom of the carat in character bitmap 10 has disappeared (been filled in) because of the bolding. To prevent this type of distortion, the bolding process of the present invention uses neighboring pixel detection to determine which pixels must remain inactive.

FIGS. 5A and 5B illustrate a standard character bitmap 40 and a bolded character bitmap 42 to demonstrate neighboring pixel detection in accordance with one embodiment of the present invention. Standard character bitmap 40 includes three active pixels (1, 3, and 4). Using an OR gate as described above to combine standard character bitmap 24 with a right shifted character bitmap would result in five active pixels (1-5).

To prevent overlapping active pixels, resulting in distortion, the bolding effect is not applied to pixel (1) in bolded character bitmap 42 because of the presence of an active neighboring pixel (3). A neighboring pixel is defined as a pixel that is one pixel width from the pixel to be bolded (x+2). If an active neighboring pixel is detected, the pixel will not be bolded. Therefore, since neighboring active pixel (3) was detected, pixel (1) is not bolded, therefore resulting in no change to inactive pixel (2) in bolded character bitmap 42.

Returning to the previous example, FIG. 6 illustrates a bolded character bitmap 44 after bolding in accordance with one embodiment of the present invention. Bolded character bitmap 44 includes original active pixels 12 and a set of bolded active pixels 46 added to bolded character bitmap 44 after completing the bolding process described above. Character bitmap 44 also includes a neighboring active pixel 46, which was detected by the processor. The detection prevented bolding of active pixel 12′ and therefore inactive pixel 14′ remained inactive instead of being changed to a bolded active pixel.

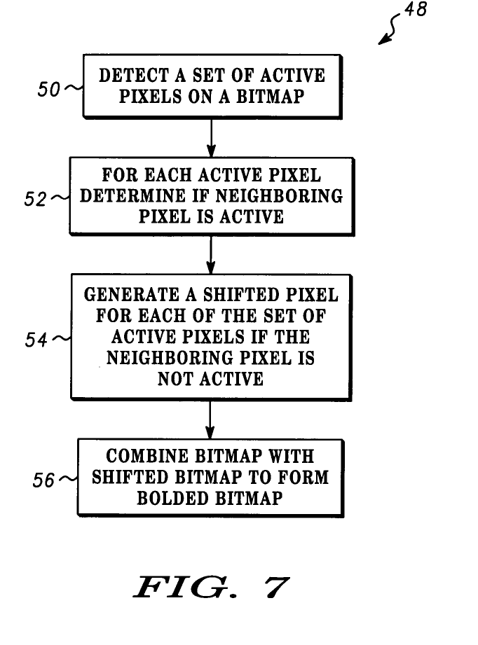

FIG. 7 is a flow chart of a method 48 for providing a bolded character bitmap in accordance with one embodiment of the present invention. Method 48 begins at a block 50 where a processor detects a set of active pixels on a character bitmap. The processor then determines for each active pixel in a block 52, whether a neighboring row pixel is active. As described above, a neighboring pixel is located two pixels to the right (x+2) of each active pixel, however the distance of the neighboring pixel may be increased to suit the particular character bitmap (such as bitmaps of higher resolution).

In a block 54, the processor generates a shifted active pixel (x+1) for each of the set of active pixels if the neighboring pixel (x+2) is not active (shift right in each row y). The shifted active pixels result in a shifted character bitmap for each row of pixels in the character bitmap. It should be noted that while right shifting has been used above as an example, it is also possible to generate a bold font by left shifting pixels. For example, the shifted active pixel may be located one pixel to the left (x−1) of the active pixel while the neighboring pixel is located two pixels to the left (x−2). This example is thefeore used for a shift left in each row y bolding operation. Method 48 ends at a block 56 where the character bitmap is combined with the shifted character bitmap to generate a bolded character bitmap.

One advantage of the present invention is that bitmapped fonts of all sizes, shapes, and styles may be bolded without adding pre-made bitmaps that may consume precious memory. This is particularly true in electronic devices that must have multi-lingual function and handle the extremely large set of CJK characters. As described above, memory conservation is particularly important in hand held devices, most of which are equipped with very little memory.

Typically the memory unit 22 for the device 18 (a cellular telephone) has 64 MBs of memory and the display 26 has 16×16 pixel dimensions for its text character bitmaps. Hence, advantageously by utilizing the present invention the need to store bolded character bitmaps is eliminated, thereby typically freeing around 350 KB of additional memory. Instead of being used to store character bitmaps, the 350 KB may be used to store three to four additional applications, such as an address book or a clock. Because displays with higher resolutions and additional fonts are always being developed, the memory saved will continue to increase in such future devices.

The detailed description provides preferred exemplary embodiments only, and is not intended to limit the scope, applicability, or configuration of the invention. Rather, the detailed description of the preferred exemplary embodiments provides those skilled in the art with enabling descriptions for implementing preferred exemplary embodiments of the invention. It should be understood that various changes may be made in the function and arrangement of elements without departing from the spirit and scope of the invention as set forth in the appended claims.

1. A method for providing a bolded character bitmap, comprising:
detecting an active pixel on a character bitmap;
determining if a neighboring row pixel for said active pixel is active;
generating a shifted active pixel for said active pixel if said neighboring pixel is not active to generate a shifted character bitmap for each row of pixels in the character bitmap; and
combining said character bitmap with said shifted character bitmap to generate said bolded character bitmap.

2. A method for providing a bolded character bitmap as recited in claim 1, wherein the shifted active pixel is located adjacent, in the row, to the active pixel.

3. A method for providing a bolded character bitmap as recited in claim 2, wherein the neighboring pixel is located a distance of one pixel, in the row, from each active pixel.

4. A method for providing a bolded character bitmap as recited in claim 1, wherein the text character is selected from a group consisting of Chinese, Japanese and Korean fonts.

5. A method for providing a bolded character bitmap, as recited in claim 1, wherein the bolded character bitmap is provided for a hand held device.

6. A digital image device, comprising:
a memory unit for storing a character bitmap;
an input buffer for receiving said character bitmap from said memory unit;
a processor coupled to said input buffer, wherein said processor is to generate a bolded character bitmap by applying a bolding process, wherein said bolding process is to determine if a neighboring row pixel for each active pixel in said character bitmap is active; and
an output buffer coupled to said processor for storing and transmitting said bolded character bitmap.

7. A digital image device as recited in claim 6, wherein the bolding process is to generate a shifted active pixel for each active pixel if the neighboring pixel is active to generate a shifted character bitmap.

8. A digital image device as recited in claim 7, wherein the bolding process is to combine the character bitmap with the shifted character bitmap to generate the bolded character bitmap.

9. A digital image device as recited in claim 8, further comprising a display coupled to the output buffer through a column driver and a row driver.

10. A digital image device as recited in claim 9, wherein said display is a liquid crystal display.

11. A digital image device as recited in claim 10, further comprising a transceiver coupled to the processor.

12. A method for providing a bolded character bitmap, comprising:
detecting an active pixel on a character bitmap;
determining if a neighboring row pixel for said active pixel is active; and
generating a shifted active pixel for said active pixel if said neighboring pixel is not active to generate said bolded character bitmap.

13. A method for providing a bolded character bitmap as recited in claim 12, wherein the neighboring pixel is located a distance of one pixel, in the row, from each active pixel.

14. A method for providing a bolded character bitmap as recited in claim 12, wherein the neighboring pixel is located a distance of one pixel to the right, in the row, from each active pixel.

15. A method for providing a bolded character bitmap as recited in claim 12, wherein the neighboring pixel is located a distance of one pixel to the left, in the row, from each active pixel.

16. A method for providing a bolded character bitmap as recited in claim 14, wherein the generating a shifted active pixel for said active pixel is characterised by the shifted active pixel being shifted by one pixel to the right in the row.

17. A method for providing a bolded character bitmap as recited in claim 15, wherein the generating a shifted active pixel for said active pixel is characterised by the shifted active pixel being shifted one pixel to the left in the row.
